(19) United States
(12) Patent Application Publication
(10) Pub. No.: US 2011/0168623 A1
(43) Pub. Date: Jul. 14, 2011

(54) FEED SIDE PASSAGE MATERIAL AND SPIRAL SEPARATION MEMBRANE ELEMENT

(76) Inventors: Yasuhiro Uda, Ibaraki-shi (JP); Naoki Kurata, Ibaraki-shi (JP); Yuuji Yamashiro, Ibaraki-shi (JP); Kouji Maruyama, Ibaraki-shi (JP); Takahisa Konishi, Ibaraki-shi (JP)

(21) Appl. No.: 13/062,759

(22) PCT Filed: Sep. 8, 2009
(86) PCT No.: PCT/JP2009/065640

§ 371 Date: Mar. 8, 2011

(30) Foreign Application Priority Data
Sep. 9, 2008 (JP) 2008-231182

(51) Int. Cl. B01D 63/00; B01D 63/10; B01D 71/00; B01D 65/02

(52) U.S. Cl. 210/494.1; 210/501

(57) ABSTRACT

A feed side passage material is provided in which sufficient antibacterial activity is obtained even in the spaces among constituent yarns and which hence can effectively prevent biofouling. Also provided is a spiral separation-membrane element employing the feed side passage material. The feed side passage material, which is for use in a spiral separation-membrane element, is a feed side passage material in a net form constituted of yarns (1 and 2) containing a chlorophenol compound antibacterial. The spiral separation-membrane element comprises a perforated hollow core tube and, wound therearound, one or more separation membranes, one or more feed side passage materials, and one or more permeate side passage materials. The element is characterized in that the feed side passage materials each is said feed side passage material.

### TECHNICAL FIELD

The present invention relates to a feed side passage material for use in a spiral separation membrane element that separates a component existing in a liquid as well as to a spiral separation membrane element using the feed side passage material, and more particularly to a technique of imparting an antibacterial property to a spiral separation membrane element.

### BACKGROUND ART

Conventionally, as a structure of a spiral separation membrane element, there is known one in which one or more separation membranes, one or more feed side passage materials, and one or more permeate side passage materials are wound around a perforated core tube (for example, see the patent document 1). In such a spiral separation membrane element, a feed side fluid (stock water) is guided to a separation membrane surface by the feed side passage material and, after being separated by being permeated through the separation membrane, a permeate side fluid (permeated water) is guided along the permeate side passage material to the core tube (water-collecting tube). For this feed side passage material, a net made of resin such as polypropylene has been mainly used.

Generally, the liquid supplied to the separation membrane element contains bacteria or microorganisms, so that, in an operation for a long period of time, the microorganisms proliferate around the stock water side passage material to form a biological membrane, thereby leading to a state known as biofouling. In this state, the flow resistance of the stock water side passage material increases. This increases the load on a supply pump, and also generates a disadvantage in that the membrane performance decreases because the biological membrane adhering to the membrane surface acts as a resistance. For this reason, when the biofouling proceeds, there will be a need for a user to perform chemical cleaning, thereby imposing a large burden in terms of costs and labor.

For this reason, in addition to a method of performing sterilization of stock water by using an antiseptic agent such as chlorine, there is known up till now a method of imparting an antiseptic function to the separation membrane element itself. For example, the following patent document 2 discloses a separation membrane element in which an antibacterial agent is introduced into a separation membrane by a preparation method of adding a triclosan antibacterial agent into a dope (membrane-forming solution) at the time of forming a support membrane layer of the separation membrane.

However, by a method of introducing an antibacterial agent into a separation membrane, because the processed water is permeated in one direction within the membrane, an antibacterial effect to the stock water side before contact with the antibacterial agent is hardly generated, though an effect is produced in controlling the microorganisms of the permeated water. For this reason, there has not been a direct effect of preventing proliferation of bacteria or microorganisms by adhesion to the surface of the separation membrane or the feed side passage material on which deposition of bacteria or the like is particularly liable to be generated.

Further, in consideration of an actual spiral element construction, the volume (volume) per unit area thereof is larger in the feed side passage material, so that, by a method of introducing an antibacterial agent into a separation membrane, it is not possible to increase the absolute amount by which the antibacterial agent is retained, thereby making it difficult to maintain the antibacterial effect for a long period of time.

Also, the following patent document 3 discloses a separation membrane element made by dispersing an antibacterial agent into a feed side passage material or coating a feed side passage material with an antibacterial agent. As this antibacterial agent, silver zeolite, a compound having an amidine group or a guanidine group, a tertiary ammonium salt, and the like are exemplified.

### Prior Art Documents

### Patent Documents

Patent Document 1: Japanese Patent Application Laid-open No. 2000-42378 Gazette
Patent Document 2: United States Patent No. 6540915 Specification
Patent Document 3: Japanese Patent Application Laid-open No. 08-332489 Gazette

### SUMMARY OF THE INVENTION

### Problems that the Invention is to Solve

However, it has been found out that none of the above antibacterial agents disclosed in the patent document 3, when used in a feed side passage material, produces a sufficient proliferation-suppressing effect to Escherichia coli. Namely, since the feed side passage material is generally formed in a net shape, an antibacterial function is needed even in a gap region between the constituent yarns of the net; however, it has been found out that the above antibacterial agents do not produce an antibacterial effect in such a gap region.

In particular, when an organic antibacterial agent disclosed in the patent document 3 is used, the solubility is too high, making it difficult to extend the retaining time. Also, an inorganic antibacterial agent such as a silver antibacterial agent has a low sustained-release property or a low diffusion function, so that the antibacterial area is narrow, thereby raising a problem in that the effect thereof is hardly extended to the space as a whole that is needed.

Therefore, an object of the present invention is to provide a feed side passage material and a spiral separation membrane element using the feed side passage material that can effectively prevent biofouling because a sufficient antibacterial function is obtained even in the gap region between the constituting yarns.

### Means for Solving the Problems

The present inventors and others have made eager studies and found out that the aforementioned object can be achieved by allowing a chlorophenol antibacterial agent to be contained in the net-constituting yarns, thereby completing the present invention.

Namely, the feed side passage material of the present invention is a feed side passage material for use in a spiral separation membrane element, characterized in that net-constituting yarns constituting the feed side passage material having a net shape contain a chlorophenol antibacterial agent.

According to the feed side passage material of the present invention, as will be shown in the results of the Examples, by allowing a chlorophenol antibacterial agent to be contained in the net-constituting yarns, it is possible to provide a feed side passage material that can effectively prevent biofouling because a sufficient antibacterial function is obtained even in the gap region between the constituting yarns.

In the present invention, a sufficient antibacterial function is obtained in the gap region between the constituting yarns even when the net-constituting yarns have an intersection point interval of 4 to 15 mm.

In the present invention, it is preferable that the chlorophenol antibacterial agent is triclosan (2,4,4′-trichloro-2′-hydroxy diphenyl ether) or a derivative thereof.

Also, it is preferable that a content of the chlorophenol antibacterial agent is 0.005 to 10 wt % in the total weight. With such a content of the antibacterial agent, a sufficient antibacterial function is obtained even in the gap region between the constituent yarns, and a strength or the like of the passage material can be sufficiently maintained.

Further, it is preferable that the chlorophenol antibacterial agent is dispersed in the resin that forms the net-constituting yarns. For use in an environment in which a high-pressure water stream is generated such as in a spiral separation membrane element, deterioration with lapse of time is liable to occur in the case of coating. For this reason, in view of the durability of the antibacterial effect, it is preferable that the chlorophenol antibacterial agent is dispersed in the resin that forms the net-constituting yarns.

On the other hand, the spiral separation membrane element of the present invention is a spiral separation membrane element in which one or more separation membranes, one or more feed side passage materials, and one or more permeate side passage materials are wound around a perforated hollow core tube, characterized in that the feed side passage material is a feed side passage material described above.

According to the spiral separation membrane element of the present invention, since the feed side passage material of the present invention is used, it is possible to provide a spiral separation membrane element that can effectively prevent biofouling because a sufficient antibacterial function is obtained even in the gap region between the constituent yarns.

In the above, it is preferable that the separation membrane contains an inorganic antibacterial agent. Generally, an inorganic antibacterial agent has a high safety against toxicity or the like and a high durability, and has a wide range of applicable bacteria species. However, the antibacterial power or the sterilizing power is weak such as shown by a considerably narrow bacterial resistance enabling region. Conversely, an organic series has a high sustained-release property or a high diffusion property, so that the antibacterial power or the sterilizing power is high; however, there are problems such as a low durability and a narrow range of applicable bacteria species. For example, triclosan which is an organic antibacterial agent has a small or comparatively small antibacterial effect on Pseudomonas aeruginosa, Aspergillus niger, Candida yeast, and the like; however, Novalon (silver antibacterial agent) which is an inorganic antibacterial agent exhibits a sufficient antibacterial effect even on Pseudomonas aeruginosa, Candida yeast, and the like.

Therefore, by using an inorganic antibacterial agent in the separation membrane through which water is permeated and using an organic antibacterial agent having a wide antibacterial range in the feed side passage material on whose surface the water passes, deposition of bacteria can be effectively suppressed. Though many kinds of bacteria are present in stock water, the influenced antibacterial range (antibacterial spectrum) is widened by using plural kinds of antibacterial agents, whereby proliferation of more bacteria can be suppressed than in the case of one kind. Also, generation of resistant bacteria caused by mutation of bacteria can be suppressed.

In particular, it is preferable that the separation membrane is a composite semipermeable membrane in which a skin layer including a polyamide resin produced by reaction of a polyfunctional amine component with a polyfunctional acid halide component is formed on a surface of a porous support, and an antibacterial layer containing a silver antibacterial agent and a polymer component is formed directly or via another layer on the skin layer.

In the case of using this composite semipermeable membrane, the separation membrane has an antibacterial layer containing a silver antibacterial agent and a polymer component, so that the microorganism contamination resistance property can be maintained for a long period of time by the antibacterial layer. In particular, by adjusting the weight ratio of the silver antibacterial agent and the polymer component in the antibacterial layer to be 55:45 to 95:5 (silver antibacterial agent:polymer component) and adding the silver antibacterial agent in an excessive amount as compared with the polymer component, it is possible to let a part of the silver antibacterial agent be exposed on the antibacterial layer surface, whereby an excellent microorganism contamination resistance property is exhibited. Also, since the antibacterial layer is formed directly or via another layer on the skin layer, and the antibacterial agent is not dispersed in the skin layer, the density of the skin layer is maintained. This can suppress the decrease in the performance of the skin layer, whereby not only the contamination resistance property but also the water permeation property and the salt inhibition ratio can be maintained to be high.

### BRIEF DESCRIPTION OF THE DRAWINGS

FIG. 1 is a partially fractured perspective view showing one example of a nozzle used in the method of producing a feed side passage material of the present invention.

FIG. 2 is a descriptive view describing an operation of nozzle holes.

FIG. 3 is a view showing one example of the feed side passage material of the present invention.

FIG. 4 is a photograph showing a result obtained in the antibacterial property evaluation test 1.

FIG. 5 is a photograph showing a result obtained in the antibacterial property evaluation test 2.

FIG. 6 is a graph showing a result obtained in the antibacterial property evaluation test 3.

FIG. 7 is a partially fractured perspective view showing one example of a spiral separation membrane element of the present invention.

### DESCRIPTION OF THE SYMBOLS

1 net-constituting yarn
2 net-constituting yarn
3 web section
10 nozzle hole (outside)
14 nozzle hole (inside)
C intersection
21 separation membrane
22 feed side passage material
23 permeate side passage material
25 hollow core tube

### MODES FOR CARRYING OUT THE INVENTION

Hereafter, embodiments of the present invention will be described with reference to the drawings.

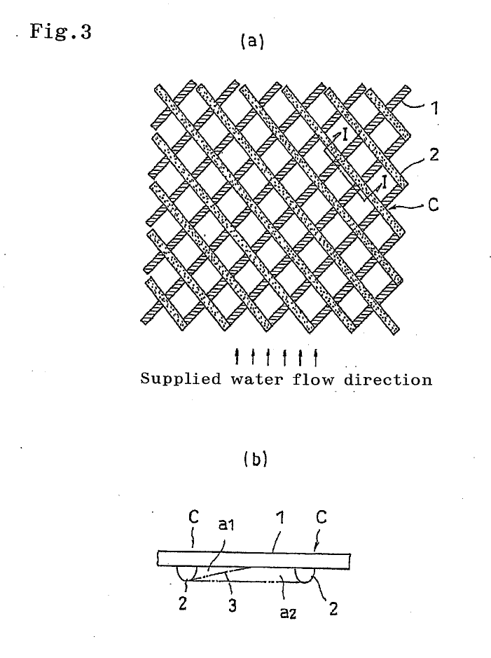

Referring to FIG. 3, the feed side passage material of the present invention is a feed side passage material for use in a spiral separation membrane element and is characterized in that the net-constituting yarns 1, 2 constituting the feed side passage material having a net shape contain a chlorophenol antibacterial agent. In the feed side passage material having a net shape, the net-constituting yarns 1, 2 need not be joined with each other; however, it is preferable that the net-constituting yarns 1, 2 are joined with each other.

The chlorophenol antibacterial agent refers to an antibacterial agent which is a phenol compound and has a chlorine group. As the chlorophenol antibacterial agent, for example, triclosan (2,4,4′-trichloro-2′-hydroxy diphenyl ether), o-chlorophenol, m-chlorophenol, p-chlorophenol, 2,4-dichlorophenol, pentachlorophenol, o-cresol, m-cresol, p-cresol, 4-chloro-m-cresol, 2,3,6-trichlorophenol, 2,3-dichlorophenol, 2,4,5-trichlorophenol, 2,4,6-trichlorophenol, 2,3,4,6-tetrachlorophenol, 4-chloro-3,5-xylenol, 2,4-dichloro-3,5-xylenol, 4-chloro-3-methyl-6-isopropylbenzene, p-chloro-o,n-amylphenol, p-chloro-o,n-hexylphenol, p-chloro-o,n-octylphenol, p-chloro-o-cyclohexylphenol, p-chloro-o-cyclopentylphenol, p-chloro-o-benzylphenol, p-chloro-o-benzyl-m-cresol, dichloro-(p-chlorobenzyl)-m-cresol, p-chloro-o-phenylphenoldichlorophene, bromochlorophene, hexachlorophene, bithionol, derivatives thereof, and the like can be used without limitation in accordance with the antibacterial function thereof. Among these, in view of the balance between the antibacterial effect and the retaining performance, those having one or two benzene rings are good, and those having two benzene rings are preferable in view of the retaining performance thereof in the case of using for water processing.

Among these, triclosan (2,4,4′-trichloro-2′-hydroxy diphenyl ether) represented by the chemical formula (chemical formula 1) or a derivative thereof can be suitably used.

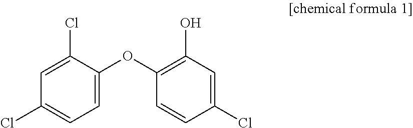

As the triclosan derivative, those in which the chlorine group of triclosan is substituted by a hydrogen atom or another halogen group, homologues in which the substitution position of these is different as well as a phosphoric acid ester, a phosphonic acid ester, a sulfuric acid ester, a glucuronic acid ester, a succinic acid ester, and a glutamic acid ester of triclosan, and the like can be raised as examples.

The method of allowing a chlorophenol antibacterial agent to be contained in the feed side passage material may be, for example, a method of mixing it in advance into a source material pellet at the time of performing extrusion molding of the passage material and uniformly dispersing it into the whole, a method of performing post-processing on the surface with a coating material containing the antibacterial agent after extrusion molding, or the like method.

In the present invention, it is preferable that the antibacterial agent is mixed and kneaded in the material for forming the feed side passage material and is dispersed into the resin that forms the net-constituting yarns. It is possible to achieve the object of the present invention by applying an antibacterial agent solution on the surface and fixing it by heating and drying; however, for use in an environment in which a high-pressure water stream is generated such as in a spiral separation membrane element, deterioration with lapse of time is liable to be generated, so that the antibacterial agent is preferably dispersed into the resin that forms the net-constituting yarns in view of the durability of the antibacterial effect.

The content of the antibacterial agent is preferably 0.005 to 10 wt % in the total weight in view of obtaining a sufficient antibacterial function even in the gap region between the constituent yarns and maintaining the strength and the like of the passage material. In particular, when the concentration is too high, the excessively eluted antibacterial agent components may adhere onto the membrane surface to decrease the permeation amount or, in the case of mixing the antibacterial agent at the time of molding and processing the feed side passage material, an inconvenience is liable to be generated in the strength of the feed side passage material or at the time of working. Therefore, the content is preferably 1 wt % or less, more preferably 0.75 wt % or less. On the other hand, when the concentration is too low, it will be difficult to obtain a sufficient antibacterial effect, so that, in the case of using it in a feed side passage material for use in a water-processing membrane, the content of 0.020 wt % or more by which the antibacterial property extends to the whole region of the feed side passage material is preferably adopted.

In the case of performing post-processing on the surface with a coating material, the content is preferably 0.005 to 1 wt %, more preferably 0.01 to 0.1 wt %, in the total weight of the coating material, from a similar viewpoint.

As the resin constituting the feed side passage material having a net shape or the base material before coating, resins such as polypropylene, polyethylene, nylon, and polyester can be raised as examples, and in particular, a polyolefin resin such as polypropylene or polyethylene is preferable.

The feed side passage material or the base material before coating of the present invention can be fabricated by shear molding or fusion molding, whereby a net-shaped product in which the net-constituting yarns 1, 2 are joined with each other at intersections C as shown in FIG. 3 can be obtained. Hereafter, description will be given by raising the shear molding method as an example.

In the case of performing shear molding, the MFR of the resin such as polypropylene according to JIS K7210:1999 is preferably 1.5 g/10 min, more preferably 1.7 to 4.0 g/10 min. When the MFR is too low, a web-like deformation is liable to be generated at the intersections. Also, when the MFR is too high, the molding of the net will be difficult.

The MFR of the resin can be adjusted typically by the weight-average molecular weight, the molecular weight distribution, the kind and the amount of the additives that are added to the resin, and the like.

As will be described later, the net obtained by shear molding is extruded in a state of having been integrated in advance at the intersections when the resin is extruded from the nozzle holes, so that the net will have a structure such that a fusion interface is absent in the net-constituting yarns.

Here, by fusion molding, the net is fused after being extruded without being integrated at the intersections when the resin is extruded from the nozzle holes, so that the net will have a structure in which a fusion interface is present in the net-constituting yarns. Also, by fusion molding, a web-like deformation is hardly generated at the intersections, as described above.

Also, in producing the net by shear molding, the total thickness of the obtained net is preferably 0.3 to 2 mm; the diameter (width) of the constituent yarns is preferably 0.08 to 1 mm; and the angle of intersection is preferably 30 to 150°. These can be achieved by adjusting the nozzle shape and the extrusion conditions.

Here, when the thickness of the net is reduced, the line speed of the membrane surface will be large, and the concentration polarization can be suppressed. However, when the thickness is reduced too much, there will be problems such as clogging of the passage by the floating components in the supply liquid or increase in the needed mechanical power of the pump that feeds the supply liquid.

In the present invention, the yarn interval and the ratio of the diameter of each of the net-constituting yarns 1, 2 can be freely changed. However, in the present invention, it is preferable that the intersection interval (yarn interval) is 4 to 15 mm, and the ratio of the diameter is 1/2 to 2/1, and it is more preferable that the intersection interval (yarn interval) is 5 to 7 mm, and the ratio of the diameter is 2/3 to 3/2,

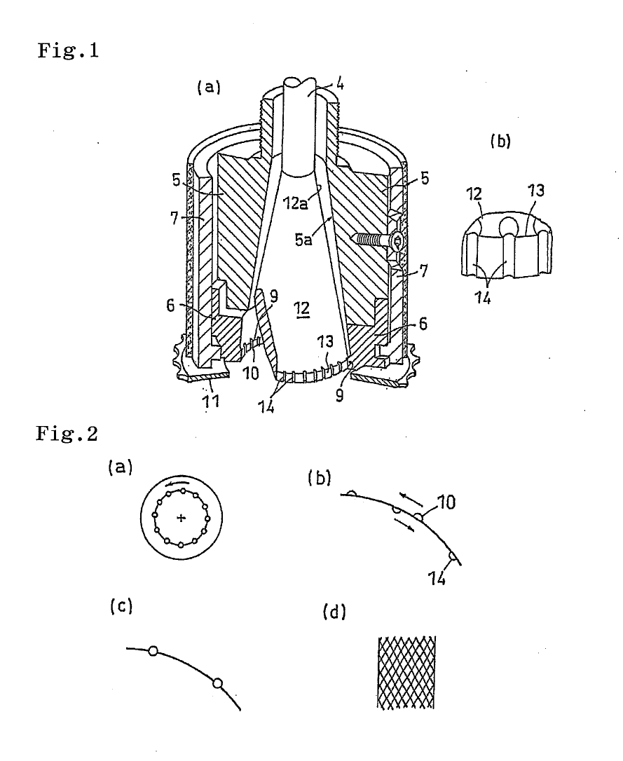

The shear molding is carried out by using, for example, an extruder equipped with a nozzle such as shown in FIGS. 1 to 2 and, while extruding each of the net-constituting yarns 1, 2 from numerous nozzle holes 14, 10 that are arranged on the two circumferences located inside and outside of the dice of the extruder, the net is molded while fusing the net-constituting yarns 1, 2 with each other at the intersections by relative rotation of the nozzle holes 14, 10 so that the two nozzle holes 14, 10 will overlap with each other to become one nozzle at the intersections of the net-constituting yarns.

Here, FIG. 1(a) is a partially fractured perspective view showing one example of a nozzle used in the method of producing a feed side passage material of the present invention, and FIG. 1(b) is an enlarged view of the nozzle holes that are arranged on the inside circumference. FIG. 2(a) is a bottom view showing an operation of the nozzle holes; FIGS. 2(b) to 2(c) are essential views showing an operation of the nozzle holes; and FIG. 2(d) is a plan view of the net obtained by this rotation operation.

The above-mentioned nozzle is equipped with an inside rotation die 12 in which the nozzle holes 14 arranged on the inside circumference are formed and an outside rotation die 6 in which the nozzle holes 10 arranged on the outside circumference are formed, and is adapted in such a manner that the outer circumferential surface 13 of the inside rotation die 12 and the inner circumferential surface 9 of the outside rotation die 6 can rotate in reverse directions while being in abutment. The inside rotation die 12 is driven by a rotation shaft 4, and the outside rotation die 6 is driven by a gear 11 that is connected to this. The outside rotation die 6 is held to be capable of free rotation by die housings 5, 7.

The resin extruded from the extruder passes through a gap between the inside surface 5a of the die housing 5 and the outer surface 12a of the inside rotation die 12 to be extruded from the nozzle holes 14, 10 thereby to become respective net-constituting yarns 1, 2. At that time, the nozzle holes 14, 10 are subjected to relative rotation (See FIG. 2(b)), and the position at which the two nozzle holes 14, 10 overlap each other to become one nozzle (See FIG. 2(c)) will be the intersection C of the net, whereby the net-constituting yarns 1, 2 will be in a state of being fused with each other. At this time, when the MFR of the resin is low, a web section 3 is liable to be generated as shown in FIG. 3(b).

The temperature at which the resin is extruded from the nozzle holes 14, 10 is preferably 230 to 300° C., more preferably 250 to 270° C. When the temperature at the time of extrusion is lower than 230° C., the fluidity of the resin will be insufficient, whereby it will be difficult to form a net, and the web deformation is liable to be generated. Also, when the temperature at the time of extrusion exceeds 300° C., the fluidity will be high to such an extent that it will be difficult to form the yarns, or the strength of the net tends to be lowered by thermal decomposition.

The extruded net is typically cooled in water or the like, collected by being wound, and then cut into a suitable size.

In the shear molding such as described above, by mixing an antibacterial agent in advance into a source material pellet, the antibacterial agent can be dispersed uniformly into the whole passage material. Also, it is possible to adopt a method of mixing an antibacterial agent in advance into only a part of the source material pellet (master batch method) or to allow an antibacterial agent to be carried in advance on porous fine particles and to mix this carrier into the source pellet. As the porous fine particles, it is possible to raise inorganic fine particles such as silica or zeolite, or porous polymer particles as an example.

On the other hand, in the case of performing post-processing on the surface with a coating material and allowing an antibacterial agent to be contained in the net-constituting yarns, the coating method is preferably a method of using a solution or molten liquid of a mixture of a coating material such as resin and an antibacterial agent and coating by immersion application, spray application, or the like.

The coating material is preferably one having a good adhesiveness to the base material of the passage material. For example, in the case of using a polyolefin resin as a base material resin, it is preferable to use a polyvinyl alcohol (PVA) resin as a coating material.

The spiral separation membrane element of the present invention has a structure such that one or more separation membranes, one or more feed side passage materials, and one or more permeate side passage materials are wound around a perforated hollow core tube. The details of such a membrane element is described in detail in the aforementioned patent document 1 or the like and, regarding the materials other than the feed side passage material, any of the conventionally known separation membranes, permeate side passage materials, and hollow core tubes can be adopted. For example, when a plurality of feed side passage materials and a plurality of permeate side passage materials are used, it will have a structure such that a plurality of membrane leaves are wound around a hollow core tube.

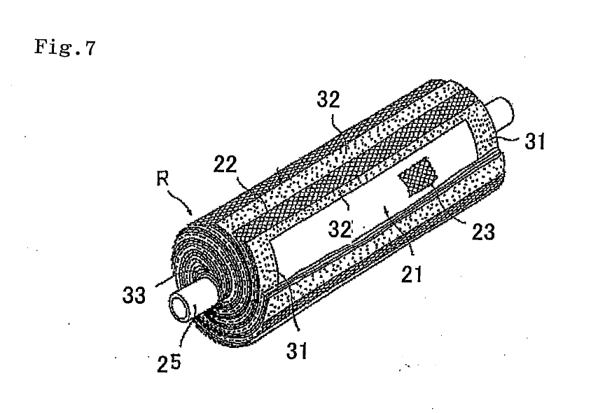

FIG. 7 is a partially fractured perspective view showing one example of a spiral separation membrane element of the prior art (present invention). This example is provided with a tubular wound body R in which a separation membrane 21, a feed side passage material 22, and a permeate side passage material 23 in a laminated state are wound in a spiral form around a perforated core tube 25, and a sealing section for preventing the feed side liquid and the permeate side liquid from being mixed with each other is provided. The sealing section includes, for example, two-end sealing sections 31 and an outer circumferential side sealing section 32, and also a sealing section 33 may be formed that seals the surroundings of the core tube 25.

Such a spiral separation membrane element can be produced by a method including a step of forming a tubular wound body R in which a separation membrane 21, a feed side passage material 22, and a permeate side passage material 23 in a laminated state are wound in a spiral form around a perforated core tube 25 and a step of forming sealing sections 31, 32 for preventing the feed side liquid and the permeate side liquid from being mixed with each other.

The use of the spiral separation membrane element of the present invention is by no means limited; however, since an antibacterial function against Escherichia coli is particularly large, the effect thereof can be particularly exhibited when it is used in a separation membrane element used for a separation process such as exhaust water processing, brine water desalination, sea water desalination, or the like.

In the present invention, the separation membrane that is put to use preferably contains an inorganic antibacterial agent. As the inorganic antibacterial agent, an antibacterial glass, a quaternary ammonium salt, a quaternary phosphonium salt, and the like can be exemplified in addition to the silver antibacterial agents described later in detail. As the separation membrane, an ultrafiltration membrane, a loose reverse osmosis membrane, a reverse osmosis membrane, and the like are preferably used.

The method of allowing an inorganic antibacterial agent to be contained may be, for example, a method of allowing a separation membrane itself (for example, a skin layer of a reverse osmosis membrane) to contain an inorganic antibacterial agent, a method of forming an antibacterial layer containing an antibacterial agent and a polymer component directly or via another layer on the separation membrane surface, or the like method. In the present invention, the method of forming an antibacterial layer directly or via another layer on the separation membrane surface is preferable because the antibacterial layer can maintain the microorganism contamination resistance property for a long period of time and also the decrease in the performance of the skin layer can be suppressed, whereby not only the contamination resistance property but also the water permeation performance and the salt inhibition ratio can be maintained to be high.

In the present invention, in particular, it is preferable that the aforesaid separation membrane is a composite semipermeable membrane in which a skin layer including a polyamide resin produced by reaction of a polyfunctional amine component with a polyfunctional acid halide component is formed on a surface of a porous support, and an antibacterial layer containing a silver antibacterial agent and a polymer component is formed directly or via another layer on the skin layer.

Also, the method of allowing a separation membrane itself (for example, a skin layer of a reverse osmosis membrane) to contain an inorganic antibacterial agent may be, for example, a method including a step of forming a skin layer containing a polyamide resin produced by reaction of a polyfunctional amine component with a polyfunctional acid halide component and a silver salt compound on a surface of a porous support and a step of reducing the aforesaid silver salt compound to allow metal silver to be deposited in the inside and/or on the surface of the aforesaid skin layer. At that time, the silver salt compound is preferably reduced by an activated energy beam, and silver nitrate is preferably used as the silver salt compound.

The polyfunctional amine component is a polyfunctional amine having two or more reactive amine groups and may be, for example, an aromatic, aliphatic, or alicyclic polyfunctional amine.

The aromatic polyfunctional amine may be, for example, m-phenylenediamine, p-phenylenediamine, o-phenylenediamine, 1,3,5-triaminobenzene, 1,2,4-triaminobenzene, 3,5-diaminobenzoic acid, 2,4-diaminotoluene, 2,6-diaminotoluene, N,N′-dimethyl-m-phenylenediamine, 2,4-diaminoanisole, amidol, xylylenediamine, or the like.

The aliphatic polyfunctional amine may be, for example, ethylenediamine, propylenediamine, tris(2-aminoethyl)amine, n-phenyl-ethylenediamine, or the like.

The alicyclic polyfunctional amine may be, for example, 1,3-diaminocyclohexane, 1,2-diaminocyclohexane, 1,4-diaminocyclohexane, piperazine, 2,5-dimethylpiperazine, 4-aminomethylpiperazine, or the like.

The polyfunctional acid halide component is a polyfunctional acid halide having two or more reactive carbonyl groups. The polyfunctional acid halide may be, for example, an aromatic, aliphatic, or alicyclic polyfunctional acid halide.

The aromatic polyfunctional acid halide may be, for example, trimesic acid trichloride, terephthalic acid dichloride, isophthalic acid dichloride, biphenyldicarboxylic acid dichloride, naphthalenedicarboxylic acid dichloride, benzenetrisulfonic acid trichloride, benzenedisulfonic acid dichloride, chlorosulfonylbenzenedicarboxylic acid dichloride, or the like.

The aliphatic polyfunctional acid halide may be, for example, propanedicarboxylic acid dichloride, butanedicarboxylic acid dichloride, pentanedicarboxylic acid dichloride, propanetricarboxylic acid trichloride, butanetricarboxylic acid trichloride, pentanetricarboxylic acid trichloride, glutaryl halide, adipoyl halide, or the like.

The alicyclic polyfunctional acid halide may be, for example, cyclopropanetricarboxylic acid trichloride, cyclobutanetetracarboxylic acid tetrachloride, cyclopentanetricarboxylic acid trichloride, cyclopentanetetracarboxylic acid tetrachloride, cyclohexanetricarboxylic acid trichloride, tetrahydrofurantetracarboxylic acid tetrachloride, cyclopentanedicarboxylic acid dichloride, cyclobutanedicarboxylic acid dichloride, cyclohexanedicarboxylic acid dichloride, tetrahydrofurandicarboxylic acid dichloride, or the like.

The porous support for supporting the skin layer is not particularly limited as long as it can support the skin layer. Typically, an ultrafiltration membrane having fine pores with an average pore diameter of 10 to 500 Å is preferably used. As the material for forming the porous support, various ones can be raised as examples such as polysulfone, polyarylethersulfone such as polyethersulfone, polyimide, polyvinylidene fluoride, and the like. The thickness of such a porous support is typically about 25 to 125 μm, preferably about 40 to 75 μm; however, the thickness is not limited to these alone. Here, the porous support is reinforced by a lining made of a base material such as a woven cloth or a nonwoven cloth

The method of forming a skin layer including a polyamide resin on the surface of a porous support is not particularly limited, so that any of the known methods can be used. For example, the interface condensation method, the phase separation method, the thin film application method, and the like may be raised as examples. The interface condensation method is specifically a method of forming a skin layer by bringing an aqueous solution of amine containing a polyfunctional amine component and an organic solution containing a polyfunctional acid halide component into contact with each other for interface polymerization and mounting the skin layer on a porous support, or a method of forming a skin layer of polyamide resin directly on a porous support by the aforesaid interface polymerization on the porous support. The details of the conditions and others of such an interface condensation method are disclosed in Japanese Patent Application Laid-open No. 58-24303, Japanese Patent Application Laid-open No. 01-180208, and others, so that those known techniques can be suitably adopted.

The thickness of the skin layer formed on the porous support is not particularly limited; however, the thickness is typically 0.05 to 2 μm, preferably 0.1 to 1 μm.

After the skin layer is formed on the surface of the porous support, an antibacterial layer containing a silver antibacterial agent and a polymer component is formed directly or via another layer on the skin layer. The weight ratio of the silver antibacterial agent and the polymer component in the antibacterial layer is preferably 55:45 to 95:5 (silver antibacterial agent:polymer component), and more preferably 60:40 to 90:10.

The silver antibacterial agent used in the present invention is not particularly limited as long as it is a compound containing a silver component, and may be, for example, metal silver, silver oxide, silver halide, a carrier containing silver ion, or the like. Among these, it is preferable to use a carrier containing silver ion, in particular. The carrier may be, for example, zeolite, silica gel, calcium phosphate, zirconium phosphate, or the like. Among these, it is preferable to use zirconium phosphate. Zirconium phosphate has a stronger hydrophobicity than other carriers, and can maintain the antibacterial effect of silver ion in water processing for a long period of time.

The average particle size of the silver antibacterial agent is preferably 1.5 μm or less, more preferably 1 μm or less. Here, the method of measuring the average particle size is as described in the Examples.

The polymer component is not particularly limited as long as it is a polymer that does not dissolve the skin layer or the porous support and is not eluted at the time of water processing operation. The polymer component may be, for example, polyvinyl alcohol, polyvinylpyrrole, polyvinylpyrrolidone, hydroxypropylcellulose, polyethylene glycol, saponified polyethylene-vinyl acetate copolymer, or the like Among these, it is preferable to use polyvinyl alcohol, and in particular it is preferable to use polyvinyl alcohol having a saponification degree of 99% or more.

The antibacterial layer is formed by applying an aqueous solution containing the aforesaid silver antibacterial agent and the aforesaid polymer component directly or via another layer (for example, a protective layer containing a hydrophilic resin) on the skin layer and thereafter drying. The application method may be, for example, spraying, applying, showering, or the like. As the solvent, an organic solvent that does not lower the performance of the skin layer or the like can be used in combination in addition to water.

The concentration of the silver antibacterial agent in the aqueous solution is preferably 0.1 to 10 wt %, more preferably 0.5 to 5 wt %. Also, the concentration of the polymer component in the aqueous solution is preferably 0.01 to 1 wt %, more preferably 0.1 to 0.7 wt %.

The thickness of the antibacterial layer is not particularly limited; however, the thickness is typically 0.05 to 5 μm, preferably 0.1 to 3 μm, more preferably 0.1 to 2 μm. When the thickness of the antibacterial layer is too small, the antibacterial property is not sufficiently exhibited, and also there is a fear that the membrane may be damaged by scraping at the time of winding a spiral element, thereby to lower the salt inhibition ratio. On the other hand, when the thickness of the antibacterial layer is too large, there is a fear that the water permeation flux may lowered below a practicable range.

The content of silver in the antibacterial layer is preferably 30 mg/m² or higher, more preferably 35 mg/m² or higher. When the content of silver is lower than 30 mg/m², it will be difficult to maintain an excellent antibacterial property for a long period of time. Also, the content of silver in the antibacterial layer is preferably 1000 mg/m² or lower, more preferably 500 mg/m² or lower, in view of the costs and the prevention of damages to the membrane.

### EXAMPLES

Hereafter, Examples and others specifically showing the construction and the effects of the present invention will be described.

### (Measurement of Permeation Flux and Salt Inhibition Ratio)

A fabricated composite semipermeable membrane having a flat membrane shape is cut into a predetermined shape and size, and is set into a cell for flat membrane evaluation. An aqueous solution containing about 1500 mg/L of NaCl and adjusted to pH 6.5 to 7.5 by using NaOH is brought into contact with the membrane at 25° C. by giving a pressure difference of 1.5 MPa between a feed side and a permeate side of the membrane. The permeation speed and the electric conductivity of the permeated water obtained by this operation is measured, so as to calculate the permeation flux (m³/m²·d) and the salt inhibition ratio (%). The salt inhibition ratio was calculated by preparing the correlation (calibration line) between the NaCl concentration and the electric conductivity of the aqueous solution in advance and by the following formula using these.

Salt inhibition ratio (%)={1−(NaCl concentration in the permeated liquid [mg/L])/(NaCl concentration in the supplied liquid [mg/L])}×100

### Example 1

With use of an extruder equipped with a nozzle shown in FIG. 1, a pellet obtained by allowing 0.025 wt % of triclosan as an antibacterial agent in a polypropylene resin (F122G manufactured by Mitsui Chemical Co., Ltd.) is introduced, and is subjected to melt-extrusion at 260° C., whereby a feed side passage material having a net shape was formed by shear molding. During this time, the nozzle shape and the extrusion condition were adjusted so that the obtained net would have a total thickness of 0.79 mm, a constituent yarn diameter (width) of 0.3 mm, a yarn interval of 5 mm, and an intersection angle of 90°.

### Comparative Example 1

A passage material was fabricated under the same condition as in Example 1 except that a pellet containing no antibacterial agent was used in Example 1.

### Comparative Example 2

A passage material was fabricated under the same condition as in Example 1 except that a pellet containing 2 wt % of silver zeolite (Bactekiller manufactured by Kanebo Kasei Co., Ltd. having a silver content of 30 wt %) as an antibacterial agent was used in Example 1.

### Antibacterial Property Evaluation Test 1

Escherichia coli K-12 was planted on an LB medium and cultivated at 35° C.×24 hours. In order to allow Escherichia coli to adhere to a passage material, a physiological saline solution containing 10³ to 10⁴ cfu/ml of Escherichia coli was prepared, and 20 ml of the bacteria liquid was put into a centrifugation tube. Each passage material was put into this one sheet by one sheet, and oscillated for one hour. The passage material was taken out, and washed for three times with 10 ml of the physiological saline solution and thereafter placed on an SCDA medium and cultivated at 35° C. for 2 to 5 days.

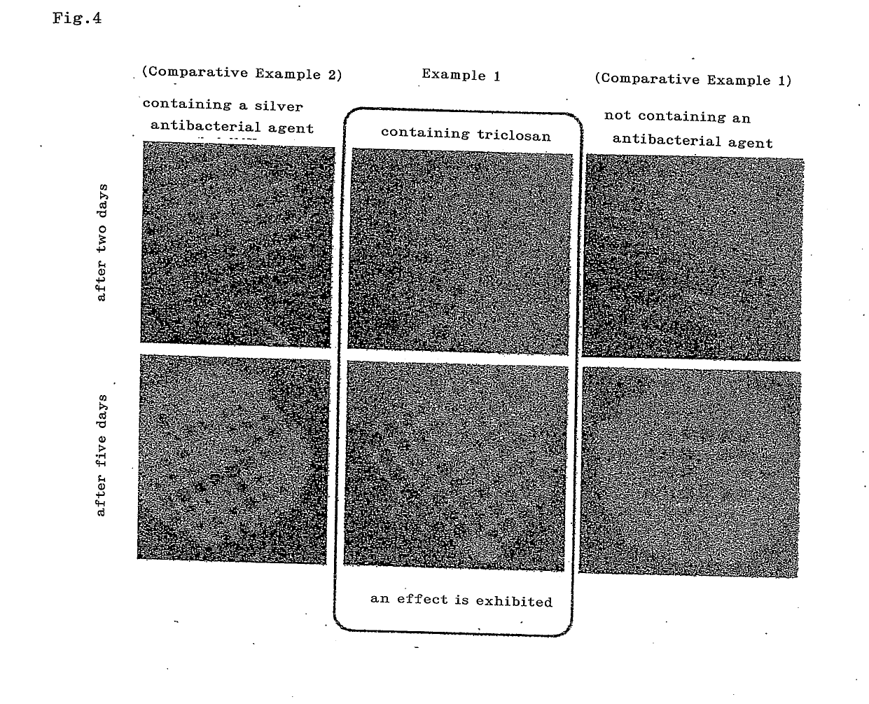

The result thereof is shown in FIG. 4. In the passage material of Example 1 containing triclosan, proliferation of bacteria was not seen. In the passage material of Comparative Example 1 containing no antibacterial agent, proliferation of a lot of bacteria was seen after 5 days. Also, in the passage material of Comparative Example 2 containing a silver antibacterial agent, proliferation of bacteria was seen, though the proliferation of bacteria was less than in the passage material containing no antibacterial agent.

### Antibacterial Property Evaluation Test 2

Escherichia coli K-12 was planted on an LB medium and cultivated at 35° C.×24 hours. As an inhibition circle formation test, a physiological saline solution containing 10⁶ to 10⁷ cfu/ml of Escherichia coli was prepared and applied on an SCDA medium. Each passage material was placed on this and cultivated at 35° C. for 2 to 5 days.

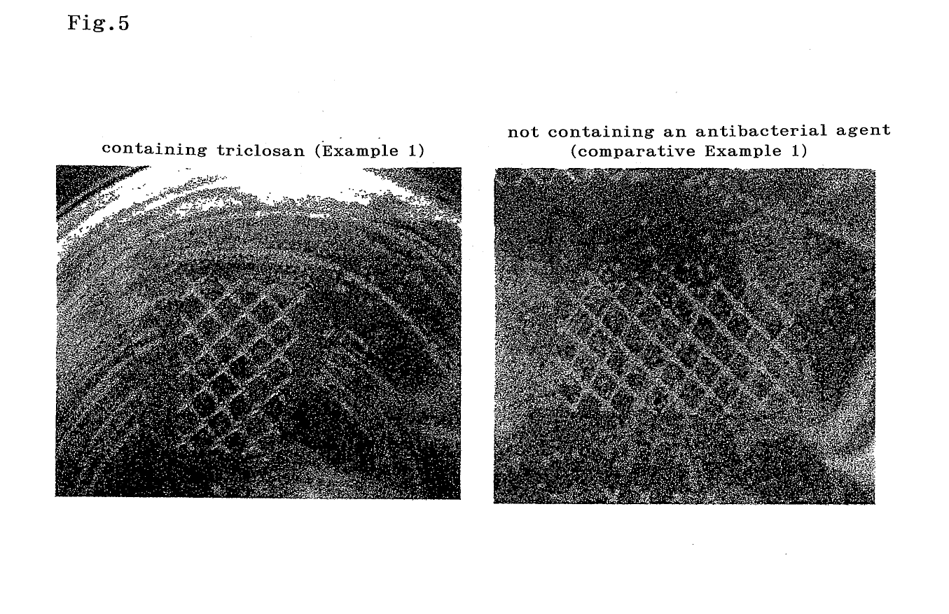

The result thereof is shown in FIG. 5. In the passage material of Example 1 containing triclosan, a region that inhibits formation of colonies was present in the inside (gap region between the constituent yarns) and the surroundings of the passage material. On the other hand, in the passage material of Comparative Example 1 containing no antibacterial agent, proliferation of bacteria was seen in the surroundings and in the inside of the passage material.

### Antibacterial Property Evaluation Test 3

Escherichia coli K-12 was planted on an LB medium and cultivated at 35° C.×24 hours. As an antibacterial power test, a prepared passage material was placed on a sterilized schale; 400 μl of an adjusted bacteria liquid containing 10⁵ cfu/ml of Escherichia coli (500 times diluted LB medium) was dropwise added; and the passage material was covered with a polyethylene film so that the liquid may not be dried. The bacteria are cultivated at 35° C. (with a humidity of 90% or more) for 24 H. After the cultivation, the bacteria liquid was collected, and the number of bacteria was counted by an SCDA medium.

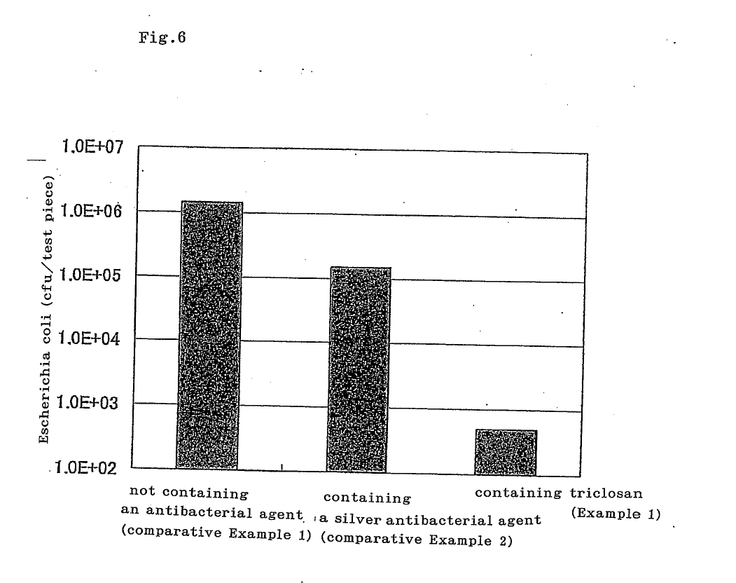

The result thereof is shown in FIG. 6. The number of bacteria in the passage material of Example 1 containing triclosan was reduced to 1/1000 as compared with the passage material of Comparative Example 1 containing no antibacterial agent. On the other hand, the number of bacteria in the passage material of Comparative Example 2 containing a silver antibacterial agent was about 1/10, so that the effect was lower as compared with triclosan used in Example 1.

### Example 2

An aqueous solution containing 1.0 wt % of a silver antibacterial agent having an average particle size of 0.9 μm (Novalon AG1100 manufactured by Toa Synthesis Co., Ltd.) and 0.5 wt % of polyvinyl alcohol (saponification degree: 99%) was applied onto a skin layer of an ultra-low-pressure reverse osmosis composite membrane (type: ES20 manufactured by Nitto Denko Co., Ltd., skin layer: polyamide resin, performance: permeation flux 1.2 (m³/m²·d) by the aforesaid measurement method, salt inhibition ratio of 99.6 (%)). Thereafter, the resultant was dried at 130° C. for 3 minutes in an oven to form an antibacterial layer, so as to fabricate a composite semipermeable membrane. A spiral separation membrane element shown in FIG. 7 was fabricated by using this composite semipermeable membrane, a feed side passage material obtained in Example 1, and a permeate side passage material (made of PET resin, thickness of 0.3 mm).

Before and after the water (having an SDI value of 3 to 6) obtained by activated sludge processing and MF membrane processing of industrial waste water at Hakozaki Site, Fukuoka Prefecture, Japan was allowed to flow through this element for about one month with a permeation flux of 0.3 to 0.4 (m³/m²·d) and a collection ratio of 15 to 20%, an evaluation test was carried out with use of an evaluation water containing 1500 ppm of NaCl and having a pH value of 6.5 to 7.0 and applying a pressure of 1.5 MPa, whereby the retaining ratio of the permeation flux was not less than 90%.

### Example 3

On a non-woven cloth base material, a solution obtained by dissolving 18 wt % of polysulfone (P-3500 manufactured by Solvay Co., Ltd.) into N,N-dimethylformamide (DMF) was uniformly applied to a Wet thickness of 200 μm, followed by immersion into a water bath at 40 to 50° C. for solidification and washing to fabricate a porous support. On this porous support, an aqueous solution of amine containing 3 wt % of m-phenylenediamine, 0.15 wt % of sodium laurylsulfate, 3 wt % of triethylamine, 6 wt % of camphorsulfonic acid, 5 wt % of isopropyl alcohol, and 0.5 wt % of silver nitrate was applied, and thereafter an extraneous aqueous solution of amine was removed to form an aqueous solution covered layer. Subsequently, on the surface of the aforesaid aqueous solution covered layer, an organic solution containing 0.2 wt % of trimesic acid chloride and naphthene hydrocarbon (Naphthesol 160 manufactured by Shin Nippon Petroleum Co., Ltd.) was applied. Thereafter, the resultant was held in a hot-air drier at 120° C. for three minutes to form a skin layer containing a polyamide resin and silver nitrate on the porous support. Thereafter, further, an ultraviolet ray of a high-voltage mercury lamp (UV-A (320 to 390 nm): 280 mJ/cm², UV-B (280 to 320 nm): 200 mJ/cm², UV-C (250 to 260 nm): 150 mJ/cm², UV-V: 70 mJ/cm²) was radiated on the skin layer surface to reduce silver nitrate to deposit metal silver in the inside and/or on the surface of the skin layer, so as to fabricate a composite semipermeable membrane. The fabricated composite semipermeable membrane had a permeation flux of 1.2 (m³/m²·d) and a salt inhibition ratio of 99 (%). Also, the fabricated composite. semipermeable membrane had an antibacterial property.

A spiral separation membrane element shown in FIG. 7 was fabricated by using this composite semipermeable membrane, a feed side passage material obtained in Example 1, and a permeate side passage material (made of PET resin, thickness of 0.3 mm). Evaluation similar to that of Example 2 was carried out on this element, whereby the retaining ratio of the permeation flux was not less than 80%.

### Example 4

A spiral separation membrane element was fabricated by using a feed side passage material fabricated in Example 1, a composite semipermeable membrane fabricated without using a silver antibacterial agent in Example 2, and a permeate side passage material (made of PET resin, thickness of 0.3 mm). Evaluation similar to that of Example 2 was carried out on this element, whereby the retaining ratio of the permeation flux was not less than 75%.

### Comparative Example 3

A spiral separation membrane element was fabricated by using a feed side passage material of Comparative Example 1, a composite semipermeable membrane fabricated without using a silver antibacterial agent in Example 2, and a permeate side passage material (made of PET resin, thickness of 0.3 mm). Evaluation similar to that of Example 2 was carried out on this element, whereby the retaining ratio of the permeation flux was about 60%.

1. A feed side passage material for use in a spiral separation membrane element, wherein net-constituting yarns constituting the feed side passage material having a net shape contain a chlorophenol antibacterial agent.

2. The feed side passage material according to claim 1, wherein said net-constituting yarns have an intersection point interval of 4 to 15 mm.

3. The feed side passage material according to claim 1, wherein said chlorophenol antibacterial agent is triclosan (2,4,4′-trichloro-2′-hydroxy diphenyl ether) or a derivative thereof.

4. The feed side passage material according to claim 1, wherein a content of said chlorophenol antibacterial agent is 0.005 to 10 wt % in the total weight.

5. The feed side passage material according to claim 1, wherein said chlorophenol antibacterial agent is dispersed in the resin that forms the net-constituting yarns.

6. A spiral separation membrane element in which one or more separation membranes, one or more feed side passage materials, and one or more permeate side passage materials are wound around a perforated hollow core tube, characterized in that said feed side passage material is a feed side passage material according to claim 1.

7. The spiral separation membrane element according to claim 6, wherein said separation membrane contains an inorganic antibacterial agent.

8. The spiral separation membrane element according to claim 6, wherein said separation membrane is a composite semipermeable membrane in which a skin layer including a polyamide resin produced by reaction of a polyfunctional amine component with a polyfunctional acid halide component is formed on a surface of a porous support, and an antibacterial layer containing a silver antibacterial agent and a polymer component is formed directly or via another layer on the skin layer.

9. The feed side passage material according to claim 2, wherein said chlorophenol antibacterial agent is triclosan (2,4,4’-trichloro-2′-hydroxy diphenyl ether) or a derivative thereof.

10. The feed side passage material according to claim 3, wherein a content of said chlorophenol antibacterial agent is 0.005 to 10 wt % in the total weight.

11. The feed side passage material according to claim 3, wherein said chlorophenol antibacterial agent is dispersed in the resin that forms the net-constituting yarns.

12. The feed side passage material according to claim 4, wherein said chlorophenol antibacterial agent is dispersed in the resin that forms the net-constituting yarns.

13. The feed side passage material according to claim 8, wherein the silver antibacterial agent and the polymer component in the antibacterial layer are present in a weight ratio of 55:45 to 95:5 (silver antibacterial agent:polymer component).
